(19) United States
(12) Patent Application Publication
(10) Pub. No.: US 2003/0121302 A1
(43) Pub. Date: Jul. 3, 2003

(54) Production of a fertilizer product

(76) Inventors: Michael John Basil Oliver, Pinetown (ZA); Milan Carsky, Pinetown (ZA); Oliver O?apos;Connor Hart, Pretoria (ZA)

Correspondence Address: ROTHWELL, FIGG, ERNST & MANBECK, P.C., 1425 K STREET, N.W., SUITE 800, WASHINGTON, DC, 20005, US

(21) Appl. No.: 10/221,445

(22) PCT Filed: Mar. 13, 2001
(86) PCT No.: PCT/IB01/00349

(30) Foreign Application Priority Data
Mar. 13, 2000 (ZA) 2000/1280

(51) Int. Cl. C05F 1/00

(52) U.S. Cl. 71/11

(57) ABSTRACT

The invention relates to a process for converting a bioorganic material such as sewage sludge into a wet, organically enriched inorganic fertilzer mix that permits drying and pelletizing into a compact particle fertilizer form. The process provides for effective odour control as well as disinfection of the bioorganic material, which are essentially required in accordance with United States Environmental Protection Agency regulations in relation to land applications of bioorganic materials. The drying and pelletizing process through heating of the fertlizer mix also serves to provide a sterilized particle fertilizer as required by the above regulations for particular applications. The process also provides for chemical reactions to occur that result in the formation of fire retardants which serve to avoid fire hazards that could otherwise be associated with the drying and pelletizing process.

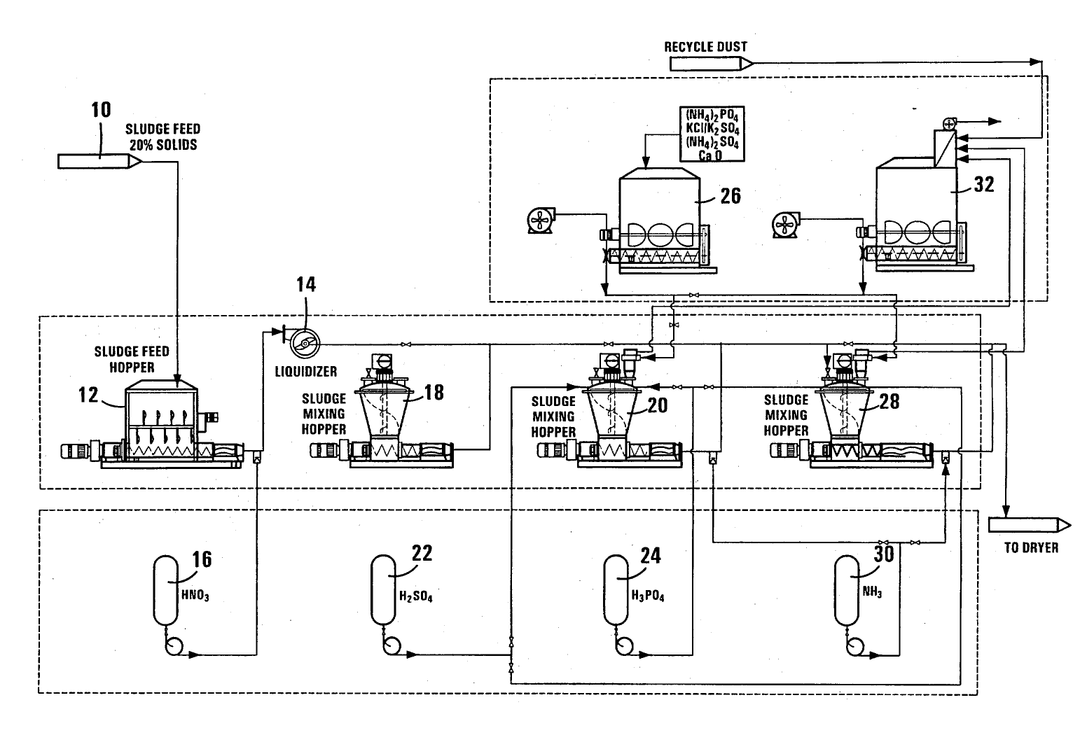

THIS INVENTION relates to the production of a compact particle fertilizer product.

The invention relates particularly also to a process for converting a bioorganic material into a wet, organically enriched inorganic fertilizer mix that can be dried and pelletized into a compact particle fertilizer, capable of being distributed by conventional agricultural fertilizer spreaders.

Insofar as the United States Environmental Protection Agency (U.S. EPA) regulates the use of bioorganic materials, such as sewage sludge, in their natural form for land applications, the present invention relates particularly to the use of such bioorganic materials, that form the subject matter of U.S. EPA regulations, as part of organically enriched inorganic compact particle fertilizers. Any reference herein to a bioorganic material and to a biosolid material must be interpreted as such.

The EPA 40 CFR Part 503 standards include in particular criteria for biosolid disposal and category options for land application. Biosolids that meet the “Class A” pathogen reduction requirements in §503.32 (a) and the vector attraction reduction requirements in §503.33 (b)(1)-(b) (8), because of their low pollutant concentration and treatment to reduce pathogens to below detectable levels and reduced vector attraction, can be sold to the public without the restrictions required for land application of bio-solids. The U.S. EPA also promulgated rules to treat waste water sludge containing odour, animal viruses, pathogenic bacteria, and parasites, which will permit use of the waste water sludge as a fertilizer for agricultural lands and application directly to land as a dry granular material.

The treatment of bioorganic materials, essentially to deal with U.S. EPA regulations, form at least part of the subject matter of various Unites States patents, including U.S. Pat. No. 4,781,842 (Nicholson), U.S. Pat. No. 4;902,431 (Nicholson et al), U.S. Pat. No. 5,013,458 (Christy et al), U.S. Pat. No. 5,135,664 (Burnham), U.S. Pat. No. 5,275,733 (Burnham), U.S. Pat. No. 5,417,861 (Burnham), U.S. Pat. No. 5,422,015 (Angell et al), U.S. Pat. No. 5,435,923 (Girovich) and U.S. Pat. No. 5,554,279 (Christy). However, the processes referred to are not considered suitable and/or economically feasible in conjunction with the production of a compact particle fertilizer formed of a bioorganic material converted to a wet, organically enriched inorganic fertilizer mix that is dried and pelletized.

It is thus particularly an object of this invention to provide a production process for converting bioorganic materials of the type above envisaged into a wet, organically enriched inorganic fertilizer mix, which can be dried and pelletized to form a compact particle fertilizer, which process is cost effective and particularly also complies with or exceeds U.S. EPA regulations for the provision of at least Class A type fertilizers and also “exceptional quality” fertilizers, both in respect of the process as such and in respect of the product produced by the process.

Drying operations involving bioorganic materials also are plagued by potential fire hazards and it is thus a further object of this invention, in relation to the use of such bioorganic materials, to alleviate this problem in the drying and pelletizing of a wet, organically enriched inorganic fertilizer mix into a compact particle fertilizer.

It is still a further object of this invention to produce an organically enriched inorganic fertilizer in a compact particle form that is suitable for distribution by conventional agricultural fertilizer spreaders.

According to the invention there is provided a process for converting a bioorganic material into a wet, organically enriched inorganic fertilizer mix that can be dried and pelletized into a compart particle fertilizer, which includes the steps of:

mixing nitric acid with the bioorganic material and liquidizing the mixture to form a substantially homogeneous paste having a pH below 2,5;

permitting the nitric acid within the paste to oxidatively react with the odorous components of the bioorganic material for deodorizing the odorous components, to degrade non-keratin proteins to peptide fragments and amino acids, to effect microbial disinfection of the bioorganic material, to eliminate pathogens, viruses and bacteria within the bioorganic material and to react with trace elements to form nitrate complexes of these elements, thereby forming a chemically deodorized and disinfected reacted paste;

further reacting the reacted paste with an acid selected from sulphuric acid, phosphoric acid and a combination of sulphuric acid and phosphoric acid, to complete the oxidative reaction with the odorous components of the bioorganic material for deodorizing the odorous components, to further degrade non-keratin proteins to peptide fragments and amino acids and to further eliminate pathogens, viruses and bacteria within the bioorganic material, thereby forming a further reacted paste; and

reacting the further reacted paste with an alkaline substance for adjusting the pH of the further reacted paste to a value more than 5 and less than 7 and for reacting with the selected acid to form sulphates if sulphuric acid is selected, phosphates if phosphoric acid is selected and sulphates and phosphates if a combination of sulphuric acid and phosphoric acids is selected and thereby forming the required wet fertilizer mix that can be dried and pelletized into a compact particle fertilizer.

The nitric acid mixed with the bioorganic material typically constitutes above 5% by weight of the mix.

The process of the invention may include permitting the nitric acid within the paste to oxidatively react with the odorous components of the bioorganic material, to degrade non-keratin proteins to peptide fragments and amino acids, to effect microbial disinfection of the bioorganic material, to eliminate pathogens, viruses and bacteria within the bioorganic material and to react with trace elements to form nitrate complexes of the trace elements, for a period of at least ten minutes.

This reaction period preferably is longer than thirty minutes.

The process may include also mixing into the further reacted paste potassium compounds from a group including potassium bicarbonate, urea potassium bicarbonate and potassium chloride. Within a compact particle fertilizer these potassium compounds will serve to enhance the fire retardant properties of the fertilizer, together with the sulphates and phosphates referred to above.

Within the process of the invention, the alkaline substance reacted with the further reacted paste for adjusting the pH of the further reacted paste typically is ammonia.

The process of the invention still further may include adding into the further reacted paste additional inorganic fertilizer substances for providing the wet fertilizer mix with a desired nitrogen/phosphorus/potassium (NPK) composition. It is well known in this regard that fertilizers for different applications require different NPK compositions and the addition of the said additional inorganic fertilizer substances clearly can provide for a fertilizer to have a specific required NPK composition.

The invention extends also to a process for producing an organically enriched inorganic fertiliser, which includes the steps of

providing, by the conversion of a bioorganic material, a wet organically enriched inorganic fertilizer mix; and

sterilizing the mix and pelletizing the mix into a compact particle form by heating and drying within a pelletizer apparatus.

The conversion of the bioorganic material into a wet organically enriched inorganic fertilizer mix particularly may be carried our in accordance with the process for converting a bioorganic material into a wet, organically enriched inorganic fertilizer mix that can be dried and pelletized into a compact particle fertilizer, in accordance with the present invention.

Pelletizing of the wet organically enriched inorganic fertilizer mix into a compact particle form particularly may be carried out within a fluidized bed apparatus.

The processes of the invention are described in more detail hereinafter, by way of example, with reference to the accompanying diagrammatic flow diagram which illustrates particularly a process for converting a bioorganic material into a wet organically enriched inorganic fertilizer mix that can be dried and pelletized into a compact particle fertilizer.

Referring to the flow diagram, the process for converting a bioorganic material into a wet organically enriched inorganic fertilizer mix that can be dried and pelletized into a compact particle fertilizer, in accordance with the invention, incorporates the feed of a bioorganic sludge material from a supply source 10 to a hopper, the hopper incorporating a displacement means for displacing the sludge therefrom. The bioorganic sludge material typically consists of sewage sludge.

The first step in the process provides for the feed of the bioorganic sludge material at a controlled rate to a liquidizer 14, nitric acid being fed at a controlled rate into the sludge flow line, from a supply source 16, at an upstream location of the liquidizer. The liquidizer 14 provides for effective mixing of the sludge material and the nitric acid into a substantially homogeneous paste form, the quantity of nitric acid constituting in excess of 5% of the weight of the mix. This quantity particularly is such that the pH of the mix is below 2,5. The mixture of nitric acid and bioorganic material is fed into a first hopper 18 within which the nitric acid within the paste is permitted to oxidatively react with the odorous components of the bioorganic material for deodorizing the odorous components, to degrade non-keratin proteins to peptide fragments and amino acids, to effect microbial disinfection of the bioorganic material, to eliminate pathogens, viruses and bacteria within the bioorganic material and to react with trace elements to form nitrate complexes of these elements, thereby forming a chemically deodorized and sterilized reacted paste. The reaction time within the hopper preferably is at least thirty minutes.

The reacted paste is then displaced into a second hopper 20, into which sulphuric acid is fed at a controlled rate from a supply 22, the sulphuric acid serving to complete the oxidative reaction with the odorous components of the bioorganic material for deodorizing the odorous components, to further degrade non-keratin proteins to peptide fragments and amino acids, and to further eliminate pathogens, viruses and bacteria within the bioorganic material. The table below identifies the common odorants in bioorganic materials and their reactions with nitric acid and sulphuric acid respectively.

Common odorants in biosolids:

Odor control Reactions

| | Nitric Acid | Sulphuric Acid |
|---|---|---|
| Sulphur Compounds | | |
| Dihydrogen sulphide | H₂S + 2HNO₃ = 4H₂O + | H₂S + H₂SO₄ = S + 2H₂O + SO₂ |
| | S + 2NO | |
| Carbon disulphide | CS₂ + 4HNO₃ = CO₂ + 2S + | CS₂ + 2H₂SO₄ = CO₂ + 2S + |
| | 4NO₂ + 2H₂O | 2SO₂ + 2H₂O |
| methyl mercaptan: | CH₃SH + 2HNO₃ = H₂O + | |
| | CH₃SO₃H + 2NO | |
| Dimetyldisulphide | 3CH₃SCH₃ + 4HNO₃ = | |
| | 3CH₃SO₂CH₃ + 4NO + 2H₂O | |
| Nitrogen compounds | | |
| Ammonia | NH₃ + HNO₃ = NH₄NO₃ | 2NH₃ + H₂SO₄ = (NH₄)₂SO₄ |
| Trimethylamine: | (CH₃)₃N + HNO₃ = | (CH₃)₃N + H₂SO₄ = |
| | (CH₃)₃NHNO₃ | (CH₃)₃NH₂SO4 |
| Trimethylamine: | (C₂H₅)₃N + HNO₃ = | (C₂H₅)₃N + H₂SO₄ = |
| | (CH₃)₃NHNO₃ | (CH₃)₃NH₂SO4 |
| 2-butamine | CH₃—CHNH₂—CH₂—CH₃ + HNO₃ = | CH₃—CHNH₂—CH₂—CH₃ + H₂SO₄ = |
| | CH₃—CHNH₃NO₃—CH₂—CH₃ | CH₃—CHNH₃HSO₄—CH₂—CH₃ |
| Acetonitrile | CH₃CN + 2H₂O = CH₃COOH + | |
| | NH₃ (acid hydrolysis) | |
| Alcohols and ketones | | |
| Methanol: | CH₃OH + HNO₃ = H₂O + | 2CH₃OH + H₂SO₄ = 2H₂O + |
| | CH₃NO₃ | (CH₃O)₂SO₂ |
| ethanol: | C₂H₅OH + HNO₃ = H₂O + | 2C₂H₅OH + H₂SO₄ = 2H₂O + |
| | C₂H₅NO₃ | (C₂H₅O)₂SO₂ |
| butanol | C₄H₉OH + HNO₃ = H₂O + | 2C₄H₉OH + H₂SO₄ = 2H₂O + |
| | C₄H₉NO₃ | C₄H₉0—SO₂—O C₄H₉ |
| acetone: | CH₃—CO—CH₃ + 4HNO₃ = | |
| | CH₃COOH + 2NO + 2NO₂ + | |
| | 3H₂O + CO₂ | |
| methyl-ethyl ketone: | CH₃—CO—CH₂CH₃ + 2HNO₃ = | |
| | 2CH₃COOH + 2NO + H₂O | |
| 3-methyl pentanal: | CH₃—CH₂—CHCH₃—CH₂CHO + | |
| | 2HNO₃ = CH₃—CH₂—CHCH₃— | |
| | CH₂COOH + 2NO₂ + H₂O | |
| Other odorants: | | |
| Acetaldehyde: | CH₃CHO + 2HNO₃ = | |
| | CH₃COOH + 2NO₂ + H₂O | |
| heptanal | CH₃(CH₂)₅CHO + 2HNO₃ = | |
| | CH₃(CH₂)₅COOH + 2NO₂ + H₂O | |
| Pentane | C₅H₁₂ + HNO₃ = C₅H₁₁NO₂ + | |
| | H₂O | |
| hexane | C₆H₁₄ + HNO₃ = C₆H₁₃NO₂ + | |
| | H₂O | |
| octane | C₈H₁₈ + HNO₃ = C₈H₁₇ NO₂ + | |
| | H₂O | |

The process of the invention further includes feeding phosphoric acid at a controlled rate from a supply 24 into the hopper 20, providing downstream for the reactions of sulphuric acid and phosphoric acid with ammonia, to provide respectively ammonium sulphate and ammonium dihydrogen phosphate, which will provide a dried and pelletized compact particle fertilizer formed, with required fire retardant properties. Optionally at this stage, dry calcium oxide can be fed at a controlled rate from a hopper 26 into the hopper 20, which will also react with the sulphuric acid and the phosphoric acid.

A further step in the process provides for the feed of the further reacted paste from the hopper 20 to a hopper 28, with the ammonia referred to above being fed from a supply 30 into the further reacted paste upstream of the hopper 28. The ammonia serves as an alkaline substance that can react with the further reacted paste for adjusting the pH of the further reacted paste, the quantity of ammonia being such that the pH is adjusted to a value more than 5 and less than 7, which is required for a fertilizer. The formation of the sulphates and phosphates referred to above also occurs at this stage.

Additional dry chemical substances including any one of or a combination of di-ammonium phosphate, potassium chloride, potassium sulphate, ammonium sulphate and calcium oxide can be fed from the hopper 26 into either hopper, 20 or 28, whereas dry chemicals including potassium bicarbonate, urea potassium bicarbonate, and other inorganic fertilizer substances can be mixed at a controlled rate into the said further reacted paste from a hopper 32, particularly to provide the final mix that is formed with a required NPK composition as determined by the requirements of the fertilizer to be produced. The process of the invention is greatly variable in this respect. The final mix can hence be conveyed to a dryer and pelletizer which, typically, is a fluidized bed-type dryer, in order to form a sterilized dried and pelletized compact particle fertilizer of a desired particle size. The complete process for forming a dry compact particle fertilizer thus incorporates the process of converting a bioorganic material into a wet organically enriched inorganic fertilizer mix, as above described and illustrated in the flow diagram, together with the subsequent drying and pelletizing stage in order to form the required fertilizer product. Re-cycle dust from the dryer used in the process also may be fed back to the final mix via the hopper 32, enhancing thereby the drying and pelletizing process.

Referring to the above process as described and particularly the reactions of the bioorganic material with nitric acid and sulphuric acid, disinfection of the bioorganic material will occur as a result of protein destruction by the acids and the formation of peptide fragments and amino acids. This disinfection process is already well known and, as such, is not described in further detail herein. Final sterilization of the product being produced in fact occurs during drying and pelletizing, which occurs as suitably high temperatures for required time periods.

It will be appreciated that the apparatus associated with the process and as illustrated within the flow diagram is greatly variable and that the individual hoppers utilized can be particularly adapted to induce required reactions, while the various feed mechanisms can provide for the feed of both dry and wet materials into hoppers at controlled rates, thus permitting a substantially continuous process.

It must also be understood that the specific process steps as defined can be varied in various different respects while still incorporating the essential features of the process steps as hereinabove described and defined and the invention extends also to variations of the process of the invention which incorporate such alternative process steps.

A compact particle fertilizer having as a major component a bioorganic material and formed in accordance with the invention will constitute an economically produced product, which complies with and generally exceeds US EPA regulations, the compact particle fertilizer constituting at least a Class A fertilizer and generally also an exceptional quality fertilizer.

By pelletizing the final mix formed within a fluidized bed-type drying and pelletizing apparatus, the compact particles formed will have a particle size range that is sufficiently constant to permit distribution by conventional agricultural fertilizer spreaders, which clearly renders use of such fertilizers practical and cost-effective.

Insofar as different NPK compositions may be required for different fertilizer applications, it will be appreciated that the process of the invention conveniently accommodates this requirement by permitting the feed of dry inorganic fertilizer substances to be mixed into the organically enriched inorganic fertilizer mix, prior to its formation into a particle form.

1. A process for converting a bioorganic material into a wet, organically enriched inorganic fertilizer mix that can be dried and pelletized into a compact particle fertilizer, which includes the steps of:
mixing nitric acid with the bioorganic material and liquidizing the mixture to form a substantially homogeneous paste having a pH below 2,5;
permitting the nitric acid within the paste to oxidatively react with the odorous components of the bioorganic material for deodorizing the odorous components, to degrade non-keratin proteins to peptide fragments and amino acids, to effect microbial disinfection of the bioorganic material, to eliminate pathogens, viruses and bacteria within the bioorganic material and to react with trace elements to form nitrate complexes of these elements, thereby forming a chemically deodorized and disinfected reacted paste;
further reacting the reacted paste with an acid selected from sulphuric acid, phosphoric acid and a combination of sulphuric acid and phosphoric acid, to complete the oxidative reaction with the odorous components of the bioorganic material for deodorizing the odorous components, to further degrade non-keratin proteins to peptide fragments and amino acids and to further eliminate pathogens, viruses and bacteria within the bioorganic materia, thereby forming a further reacted paste; and
reacting the further reacted paste with an alkaline substance for adjusting the pH of the further reacted paste to a value more than 5 and less than 7 for reacting with the selected acid to form sulphates if sulphuric acid is selected, phosphates if phosphoric acid is selected and sulphates and phosphates if a combination of sulphuric acid and phosphoric acid is selected and thereby forming the required wet fertilizer mix that can be dried and pelletized into a compact particle fertilizer.

2. A process as claimed in claim 1, in which the nitric acid mixed with the bioorganic material constitutes above 5% by weight of the mix.

3. A process as claimed in claim 1 or claim 2, which includes permitting the nitric acid within the paste to oxidatively react with the odorous components of the bioorganic material, to degrade non-keratin proteins to peptide fragments and amino acids, to effect microbial disinfection of the bioorganic material, to eliminate pathogens, viruses and bacteria within the bioorganic material and to react with trace elements to form nitrate complexes of the trace elements, for a period of at least ten minutes.

4. A process as claimed in claim 3, in which the said period is longer than thirty minutes.

5. A process as claimed in any one of the preceding claims, which includes mixing into the further reacted paste potassium compounds from a group including potassium bicarbonate, urea potassium bicarbonate and potassium chloride.

6. A process as claimed in any one of the preceding claims, in which the alkaline substance reacted with the further reacted paste for adjusting the pH of the further reacted paste is ammonia.

7. A process as claimed in any one of the preceding claims, which includes adding into the further reacted paste additional inorganic fertilizer substances for providing the wet fertilizer mix with a desired nitrogen/phosphorus/potassium (NPK) composition.

8. A process for producing an organically enriched inorganic fertiliser, which includes the steps of
providing, by the conversion of a bioorganic material, a wet organically enriched inorganic fertilizer mix; and
sterilizing the mix and pelletizing the mix into a compact particle form by heating and drying within a pelletizer apparatus.

9. A process as claimed in claim 8, in which the conversion of the bioorganic material into a wet organically enriched inorganic fertilizer mix includes the steps of:
mixing nitric acid with the bioorganic material and liquidizing the mixture to form a substantially homogeneous paste having a pH below 2,5;
permitting the nitric acid within the paste to oxidatively react with the odorous components of the bioorganic material for deodorizing the odorous components, to degrade non-keratin proteins to peptide fragments and amino acids, to effect microbial disinfection of the bioorganic material, to eliminate pathogens, viruses and bacteria within the bioorganic material and to react with trace elements to form nitrate complexes of these elements, thereby forming a chemically deodorized and disinfected reacted paste;
further reacting the reacted paste with an acid selected from sulphuric acid, phosphoric acid and a combination of sulphuric and phosphoric acid, to complete the oxidative reaction with the odorous components of the bioorganic material for deodorizing the odorous components, to further degrade non-keratin proteins to peptide fragments and amino acids and to further eliminate pathogens, viruses and bacteria within the bioorganic material, thereby forming a further reacted paste; and
reacting the further reacted paste with an alkaline substance for adjusting the pH of the further reacted paste to a value more than 5 and less than 7 and for reacting with the selected acid to form sulphates if sulphuric acid is selected, phosphates is phosphoric acid is selected and sulphates and phosphates if a combination of sulphuric acid and phosphoric acid is selected and thereby forming the required wet fertilizer mix that can be dried and pelletized into a compact particle fertilizer.

10. A process as claimed in claim 9, in which the nitric acid mixed with the bioorganic material constitutes above 5% by weight of the mix.

11. A process as claimed in claim 9 or claim 10, in which the said conversion includes permitting the nitric acid within the paste to oxidatively react with the odorous components of the bioorganic material, to degrade non-keratin proteins to peptide fragments and amino acids, to effect microbial disinfection of the bioorganic material, to eliminate pathogens, viruses and bacteria within the bioorganic material and to react with trace elements to form nitrate complexes of the trace elements, for a period of at least ten minutes.

12. A process as claimed in claim 11, in which the said period is longer than thirty minutes.

13. A process as claimed in any one of claims 9 to 12, in which the conversion includes mixing into the further reacted paste potassium compounds from a group including potassium bicarbonate, urea potassium bicarbonate and potassium chloride.

14. A process as claimed in any one of claims 9 to 13, in which the alkaline substance reacted with the further reacted paste for adjusting the pH of the further reacted paste is ammonia.

15. A process as claimed in any one of claims 9 to 14, in which the conversion includes adding into the further reacted paste additional inorganic fertilizer substances for providing the wet fertilizer mix with a desired nitrogen/ phosphorus/potassium (NPK) composition.

16. A process as claimed in any one of claims 8 to 15, in which the pelletizer apparatus is a fluidized bed apparatus.

17. A process for converting a bioorganic material into a wet, organically enriched inorganic fertilizer mix that can be dried and pelletized into a compact particle fertilizer, substantially as described in the specification.

18. A process for producing an organically enriched inorganic fertilizer substantially as described in the specification.
